(19) United States
(12) Patent Application Publication
(10) Pub. No.: US 2002/0184654 A1
(43) Pub. Date: Dec. 5, 2002

(54) Program processing device and method for set-top box system

(76) Inventor: Kwang-Joong Jeong, Seoul (KR)

Correspondence Address: Y. ROCKY TSAO, Fish & Richardson P.C., 225 Franklin Street, Boston, MA, 02110-2804, US

(21) Appl. No.: 10/162,444

(22) Filed: Jun. 4, 2002

(30) Foreign Application Priority Data
Jun. 4, 2001 (KR) 2001-31234

(51) Int. Cl. H04N 7/16

(52) U.S. Cl. 725/151; 725/152

(57) ABSTRACT

Disclosed is a program processing device and method of a set-top box for adding no further program memory and accepting an execution program when the size of the execution program increases. The program processing device comprises a controller for outputting instructions for controlling the set-top, box; a first storage device for storing an execution program for executing functions of the set-top box; a program memory for storing a reproduction control program for reproducing the execution program stored in the first storage device according to signals output from the controller; and a second storage device for temporarily storing the execution program reproduced by the reproduction control program, and providing a space for executing the execution program according to the instructions by the controller.

### CROSS REFERENCE TO RELATED APPLICATION

This application is based on Korea Patent Application No. 2001-31234 filed on Jun. 4, 2001 in the Korean Intellectual Property Office, the content of which is incorporated herein by reference.

### BACKGROUND OF THE INVENTION

(a) Field of the Invention

The present invention relates to a program processing device and method for a set-top box. More specifically, the present invention relates to an apparatus and method for program processing device and method for a set-top box for utilizing a storage space of a hard disk drive to effectively use storage capacity of a program memory.

(b) Description of the Related Art

In general, a set-top box uses an embedded system that adopts essential programs required for system operation so as to process programs and reduce costs caused by system configuration.

The embedded system refers to a control system for installing a processor in the system and operating the processor, and it also totally refers to systems in which a microprocessor is inserted with no relation to sizes and performances of the microprocessor, but its scope is generally defined as a system for using a microprocessor of under 32-bit data bus.

Many restrictions are applied to the embedded system so as to reduce the total system price and the consumption power, and corresponding software is configured by using a customized real-time operating system instead of using a general-purpose operating system, or by using a single program that is loaded to the embedded system by a monitor program without an operating system and only performs necessary functions.

In general, the embedded system is classified into home appliances massively produced, and control board products produced in small quantities. Mass-produced system programs undergo many tests before they are manufactured to guarantee stable operation so that they may not be recalled after product release because of drawbacks.

Also, the embedded system displays its status by using several LEDs (light emitting diodes) and a simple LCD (liquid crystal display) instead of using a complex user interface adopted by many other systems.

A program processor of the set-top box that uses the embedded system having the above-described characteristics processes a program as follows with reference to FIG. 1.

The program processor of a conventional set-top box comprises: a CPU (central processing unit) 10 for outputting instructions for controlling the whole system; a program memory 20 for storing execution codes to be processed by the CPU 10, and providing them according to an operation by a counter; and a RAM (random access memory) 30 for storing the programs to be processed by the CPU 10.

The program memory 20 stores an execution program 22 and a reproduction control program 21 for reproducing the execution program 22 that comprises execution codes and a memory.

A conventional operation will now be described.

When the CPU 10 is initially reset and outputs to the program memory 20 a signal for reproducing the execution program to the RAM 30, the program memory 20 drives the reproduction control program 21 to reproduce the execution program to the RAM 30.

The CPU 10 executes the program reproduced to the RAM 30 to drive an embedded system. In this instance, the execution codes in the execution program may be executed in the RAM 30 or the program memory 20.

However, since the size of the execution program may be restricted according to the size of the program memory 20 in the above-described prior art, the capacity of the program memory 20 is to be increased so as to increase the size of the execution program.

The program memory represents flash memories and various kinds of ROMs (read only memories) including EEPROMs, and since their prices are very expensive per storage capacity compared to other storage devices, the corresponding cost increases as the program size required by the set-top box becomes bigger.

As the programs have become sophisticated and the application of the set-top box has also become wider, the program sizes have increased, and accordingly, requirements of the memories have greatly increased and the expenses caused by the whole system configuration have also increased, thereby diminishing price competitiveness.

### SUMMARY OF THE INVENTION

It is an object of the present invention to provide a program processing device and method of a set-top box using an embedded system for keeping an execution program without increasing memory capacity when the program size increases.

In one aspect of the present invention, a program processor of a set-top box comprises: a controller for outputting instructions for controlling the set-top box; a first storage device for storing an execution program for executing functions of the set-top box; a program memory for storing a reproduction control program for reproducing the execution program stored in the first storage device according to signals output from the controller; and a second storage device for temporarily storing the execution program reproduced by the reproduction control program, and providing a space for executing the execution program according to the instructions by the controller.

In another aspect of the present invention, a program processing method of a set-top box comprises: executing a reproduction control program, stored in a program memory, for reproducing an execution program of the set-top box stored in a first storage device; reproducing the execution program to a second storage device according to execution of the reproduction control program; and driving the execution program stored in the second storage device.

In still another aspect of the present invention, a program processor of a set-top box comprises: a controller for outputting instructions for controlling the set-top box; a first storage device for storing an execution program for executing functions of the set-top box; a program memory for storing a minimum essential routine, and a reproduction control program for reproducing the execution program and the minimum essential routine according to signals output from the controller; and a second storage device for temporarily storing the minimum essential routine and the execution program reproduced by the reproduction control program, and providing a space for executing the minimum essential routine and the execution program according to the instructions by the controller.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a conventional program processor;

FIG. 2 shows a block diagram of a program processor of a set-top box according to a first preferred embodiment of the present invention;

FIG. 3 shows a flowchart of program processing method of a set-top box according to a first preferred embodiment of the present invention;

FIG. 4 shows a block diagram of a program processor of a set-top box according to a second preferred embodiment of the present invention; and

FIG. 5 shows a flowchart of program processing method of a set-top box according to a second preferred embodiment of the present invention

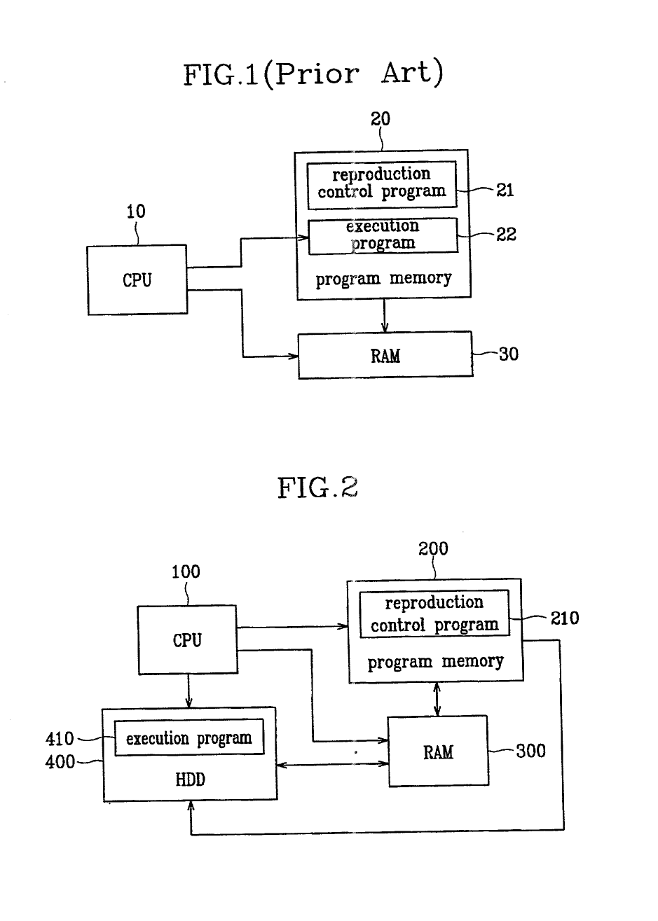

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

FIG. 2 shows a block diagram of a program processor of a set-top box according to a first preferred embodiment of the present invention.

As shown, the program processor comprises: a CPU 100 for outputting instructions for controlling the whole system; a HDD (hard disk drive) 400 for storing an execution program 410 for driving the set-top box; a RAM 300 for providing a storage space for processing the programs by the CPU 100; and a program memory 200 for storing a reproduction control program 210 for reproducing the execution program stored in the HDD 400 to the RAM 300 according to signals output from the CPU 100.

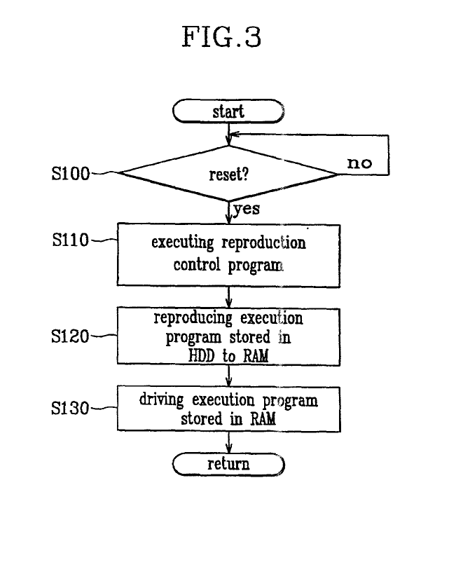

An operation of the first embodiment will now be described referring to FIG. 3.

FIG. 3 shows a flowchart of program processing method of a set-top box according to a first preferred embodiment of the present invention.

When the CPU 100 is reset in step S100, the CPU 100 drives the reproduction control program 210 stored in the program memory 200 in step S110. When the reproduction control program 210 is executed, the execution program 410 stored in the HDD 400 is reproduced to the RAM 300 according to the reproduction control program 210 in step S120. The CPU 100 drives the execution program 410 reproduced to the RAM 300 to thereby operate the whole set-top box.

According to the first preferred embodiment of the present invention, a program of big capacity that may be accommodated by the RAM 300 may be operated when the program memory 200 of small capacity is used.

That is, assuming that the capacity of the program memory 200 is 1 megabytes and the capacity of the RAM 300 is 4 megabytes, the program having the size of up to 4 megabytes may be driven using the capacity of the HDD 400.

However, when the execution program is stored in the HDD 400 and the contents in the program memory 200 are reproduced to the RAM 300 and are then executed, it is required to reset the HDD 400 when driving the CPU 100 so as to reproduce the execution program to the RAM 300, and accordingly, it is problematic that the reset time of the whole set-top box increases by the amount of the reset time of the HDD 400.

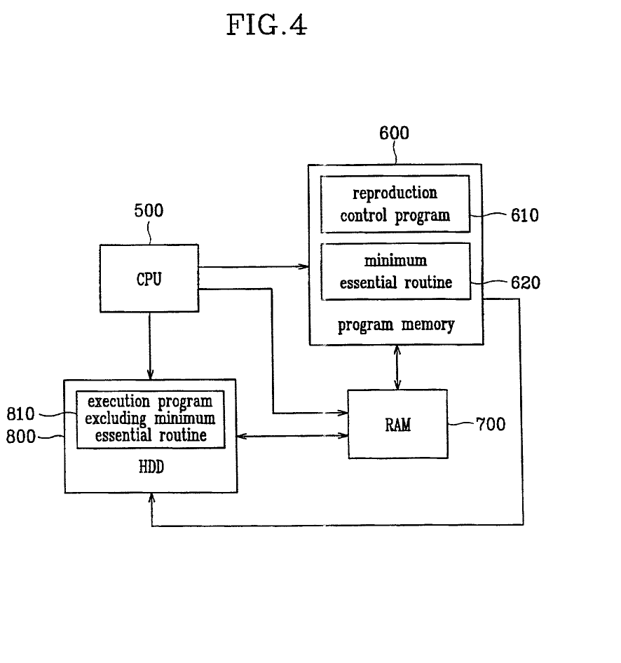

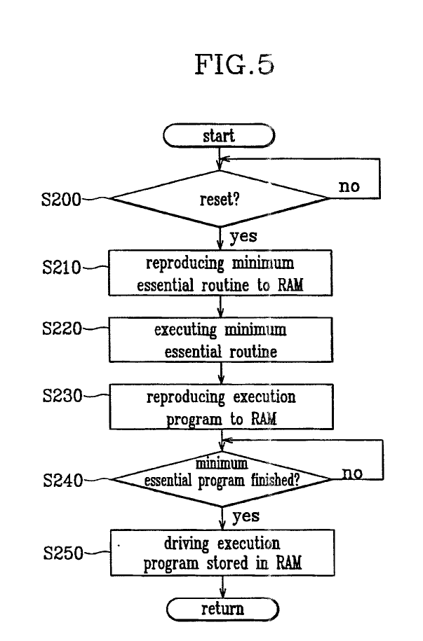

With reference to FIGS. 4 and 5, a preferred embodiment for reducing the reset time will be described.

FIG. 4 shows a block diagram of a program processor of a set-top box according to a second preferred embodiment of the present invention, and FIG. 5 shows a flowchart of program processing method of a set-top box according to a second preferred embodiment of the present invention.

As shown in FIG. 4, the program processor of a set-top box according to the second preferred embodiment of the present invention comprises: a CPU 500, a program memory 600; a RAM 700; and a HDD 800.

In the first preferred embodiment of the present invention, the whole execution program 410 is stored in the HDD 400, and in the second preferred embodiment of the present invention, a minimum essential routine 620 in the execution program is stored in the RAM 700, and the execution program 810 excluding the minimum essential routine 620 is stored in the HDD 800.

The RAM 700 provides a storage space for processing programs by the CPU 500. The program memory 600 stores a minimum essential routine 620, and a reproduction control program 610 for reproducing the execution program 810 except the minimum essential routine stored in the HDD 800 to the RAM 700.

An operation of the program processor of the set-top box according to the second preferred embodiment of the present invention will now be described with reference to FIG. 5.

When the CPU 500 is reset in step S200, the CPU 500 executes the reproduction control program 610 stored in the program memory 600 to reproduce the minimum essential routine 620 of the execution program to the RAM 700 in step S210.

The CPU 500 executes the minimum essential routine stored in the RAM 700 in step S220, and drives the reproduction control program 610 of the program memory 600 to reproduce the execution program stored in the HDD 800 except the minimum essential routine to the RAM 700 in step S230.

When finishing the execution of the minimum essential routine in step S240, the CPU 500 drives the execution program stored in the RAM except the minimum essential routine in step S250.

As operated above, since the minimum essential routine portion of the execution program is directly reproduced to the RAM 700 from the program memory 600, and is then driven, and the remaining portion of the execution program is reproduced to the RAM 700 from the HDD 800, and is then executed, the whole execution program may be driven, and the time delay to problem caused by the HDD reset time is solved.

That is, since the initial system booting time of about greater than 10 seconds is reduced to about 3 to 4 seconds, the user's dissatisfaction caused by the initial booting delay is overcome.

Therefore, the present invention enables to use less program memories and drive programs of big capacity greater than the capacity of the program memory in the program processor of the set-top box.

Further, since the present invention drives the program of big capacity and minimizes the reset time interval, the user's dissatisfaction according to the initial system booting is solved.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A program processor of a set-top box, comprising:
a controller for outputting instructions for controlling the set-top box;
a first storage device for storing an execution program for executing functions of the set-top box;
a program memory for storing a reproduction control program for reproducing the execution program stored in the first storage device according to signals output from the controller; and
a second storage device for temporarily storing the execution program reproduced by the reproduction control program, and providing a space for executing the execution program according to the instructions by the controller.

2. A program processing method of a set-top box, comprising:
executing a reproduction control program, stored in a program memory, for reproducing an execution program of the set-top box stored in a first storage device;
reproducing the execution program to a second storage device according to execution of the reproduction control program; and
driving the execution program stored in the second storage device.

3. A program processor of a set-top box, comprising:
a controller for outputting instructions for controlling the set-top box;
a first storage device for storing an execution program for executing functions of the set-top box;
a program memory for storing a minimum essential routine, and a reproduction control program for reproducing the execution program and the minimum essential routine according to signals output from the controller; and
a second storage device for temporarily storing the minimum essential routine and the execution program reproduced by the reproduction control program, and providing a space for executing the minimum essential routine and the execution program according to the instructions by the controller.

4. A program processing method of a set-top box, comprising:
driving a reproduction control program stored in a program memory, reproducing a minimum essential routine of an execution program of the set-top box stored in the program memory to a first storage device, and executing the same;
driving the reproduction control program to reproduce the execution program stored in a second storage device to the first storage device; and
driving the execution program when the execution of the minimum essential routine is finished.
